(19) United States
(12) Patent Application Publication
(10) Pub. No.: US 2021/0191336 A1
(43) Pub. Date: Jun. 24, 2021

(54) MECHANICALLY DRIVEN DISPLAY

(71) Applicant: Benoît MINTIENS, Lint (BE)

(72) Inventor: Benoît MINTIENS, Lint (BE)

(21) Appl. No.: 17/131,410

(22) Filed: Dec. 22, 2020

(30) Foreign Application Priority Data
Dec. 24, 2019 (BE) 2019/5983

(51) Int. Cl. G04B 45/00; G04B 19/02; G04B 13/02

(52) U.S. Cl. CPC G04B 45/0061; G04B 13/027; G04B 19/02

(57) ABSTRACT

Mechanically driven display for showing a value of a measured quantity such as a time period or a physical parameter, whereby the display consists of a row of balls, which are moved one after the other in one row through a fixed bed by means of at least one mechanical drive, and whereby the row of balls has the colour of the background and the fixed bed but whereby one or more segments of the row of balls have a colour that visibly deviates from the background colour in which the bed is integrated.

The present invention relates to a mechanically driven display.

In particular, the invention is intended for showing quantities such as time intervals, or physical parameters such as pressure, temperature, speed or wind strength or other quantities which can be shown by means of an analogue signal or digitally by means of digits and this only by means of a mechanically driven display.

It is known that mechanical timepieces allow a very high time indication precision, as described in U.S. Pat. No. 8,743,664, and whereby such mechanical timepieces can still be automatically corrected in case of a time deviation relative to the exact time, as specified in BE 1024256.

Timepieces as specified in U.S. Pat. No. 8,743,664 show a non-conventional dial, on which the time can be read with high precision.

A disadvantage of said non-conventional dial, but also of a conventional dial is that the exact time cannot be read at a glance, considering that the position of several pointers—hours, minutes, seconds—needs to be taken into account.

The purpose of the present invention is to provide a solution to the aforementioned and other disadvantages by providing a mechanically driven display which allows a good idea to be formed of the value of the represented time interval or of another represented quantity at a glance.

Where a pointer gives an exact indication on a scale or where a digit shows an exact value, the purpose of the present invention is to provide an approximate value at a glance. In this invention the precision is subordinate to the speed of reading. The improvement consists in that the reader is able to make a good estimate of a value at a glance.

For showing a temperature on a thermometer equipped with a scale, the reader must precisely read the value on the scale and extrapolate between two gradations to get an idea of the temperature. This is also the case for a digital representation in a digit or number with which no relative position on a scale is provided.

With said invention a visible quantity can be estimated at a glance by means of a colour and/or a colour evolution and/or a colour hue as well as by means of the amount of coloured surface or length on the display.

The mechanically driven display of said invention allows both a quantitative and qualitative estimate to be formed at a glance. The length of a coloured line, for example, such as in a mercury thermometer provides a quantitative estimate. The colour of an indication, for example, such as blue for cold, and red for hot provides a qualitative estimate.

To this end, the invention relates to a mechanically driven display for showing a value of a measured quantity such as a time period or a physical parameter, whereby the display consists of a row of balls, which are moved one after the other in one row through a fixed bed by means of at least one mechanical drive, and whereby the row of balls has the colour of the background and the fixed bed but whereby one or more segments of the row of balls have a colour that visibly deviates from the background colour in which the bed is integrated.

In a first embodiment, the fixed bed is circular and the row of balls forms one consecutive string which is guided through the circular bed into two concentric tracks, of which in this case only the outer concentric track on the mechanically driven display is visible. As the segment of the row of twenty-four balls with a colour deviating from the background colour becomes visible on the outer concentric track in said embodiment, of the visible section of the segment with the twenty-four balls which each represent an hour, a first ball will be visible after one hour, two balls after two hours and twenty-four balls after twenty-four hours, for example. The row of balls will now have to be quickly turned forward or backward to the position whereby a first ball with deviating colour will become visible on the display in the coming hour, after which the whole cycle of twenty-four hours can be repeated.

Alternatively, a ball can also represent half an hour, such that twenty-four coloured balls represent a day of twelve hours and the other twenty-four non-coloured balls represent a night of twelve hours. In said alternative, the row of balls can continuously turn forward with the speed of two balls an hour, and automatically show a day of twelve hours, followed by a night of twelve hours.

The row of balls in said first embodiment is driven by at least one pinion which synchronously with the time rotates clockwise or counter-clockwise around its rotation shaft perpendicular to the readable surface of said first embodiment of a display according to the invention, whereby the balls are moved, for example at a speed of one or two balls an hour through the bed depending on the chosen time span per ball.

Preferably, the pinion engages with the balls on the level of the two points where the outer concentric track continues to the inner concentric track and each of the two engaged balls makes the transition from outer to inner concentric track or vice versa.

In a second embodiment, the bed is a linear bed and the row of balls forms one consecutive string which is guided in two parallel tracks through the linear bed, i.e. an upward and a downward track, of which in this case only the upward track is visible on the mechanically driven display.

In this case for example there are twenty-four coloured balls which can fill an entire length of the window through which they are visible on the linear display. The row of balls is driven by two pinions in this case which can simultaneously turn clockwise or counter-clockwise and make the coloured balls visible in the visible track, whereby one or more coloured balls become visible on the display, as a unit for the represented parameter.

On a timepiece this parameter can, for example, show the number of hours in a 24-hour period and this, for example, on a big pointer of the timepiece which can be provided with a linear bed. For a following 24-hour period the length shown must be turned backward or forward again until the first coloured ball appears.

Obviously this embodiment can also be used to show another parameter than the time, such as for example a physical parameter such as the temperature, whereby the upward track shows a number of coloured balls corresponding with a temperature on a temperature scale or another parameter which can be indicated in an analogue way.

Not only the length of the segment of coloured balls can be used as a unit, but a colour gradient can also be used across the segment of coloured balls, whereby the colour may also contain luminescent or phosphorescent components.

Thus the temperature can for example be shown with a linear series of balls which vary from blue to orange to red depending on the temperature reached.

In a third embodiment, the bed is an octagonal bed and the row of balls forms one consecutive string which is guided in one folded track in which seven segments of the track are linear and together form an octagonal figure.

In this case one or more segments of the row consist of coloured balls which take up one or more of the seven linear segments and make said one or more segments visible on the octagonal bed of the display. Depending on which segments of the row consist of coloured balls, the digits 0 to 9 can be shown with this, solely by making the fitting linear segments in a noticeable colour relative to the background colour of the bed and the other balls. The number of coloured segments varies from two (digit 1), to three (digit 7), to four (digit 4), to five (digits 2, 3, 5), up to six (digits 6, 9, 0).

The row of balls is driven in this case by one or more pinions which can rotate clockwise or counter-clockwise and can move the desired row of balls in the display to show the desired digit. Here it is conceivable that a fitting series of balls is selected from a carrousel with ten series, one for each digit, to show the desired digit.

It is also possible to form one long series of balls consisting of the ten desired rows for the ten digits from 0 to 9 one after the other and letting said series move up one desired row after a certain time interval, for example one hour, such that the display shows the number of expired hours up to 9 hours.

To show 24 hours, two displays can be used which together show the desired digit from 0 to 24.

Obviously such displays can also be used for other parameters than the time, such as for showing the temperature, for example, whereby the display shows the value in digital format but the drive of the display is purely mechanical.

Preferably, the balls consist of a ceramic material or a metal. The coloured balls can be provided with a coloured coating in the desired colour, whereby the coating can also be phosphorescent or luminescent to be more visible in the dark.

A segment of coloured balls in a row of balls can also vary in terms of colour within the segment. Thus, in a linear bed, in which only the upward track on the mechanically driven display is visible, the balls may vary from green to orange to red, to show a parameter, for example the temperature, not only by the length of the visible segment of coloured balls but also by its colour hue. An advantage of such a display is that it gives a good idea of the shown parameter at a glance.

The mechanically driven display for showing a value of a measured quantity according to the invention can also be applied for showing measured parameters in motion measurement systems, pedometers or gym trackers which show one or more parameters on a display.

With the intention of better showing the characteristics of the invention a few preferred embodiments of a mechanically driven display according to the invention are described hereinafter, by way of an example without any limiting nature, with reference to the accompanying drawings, wherein:

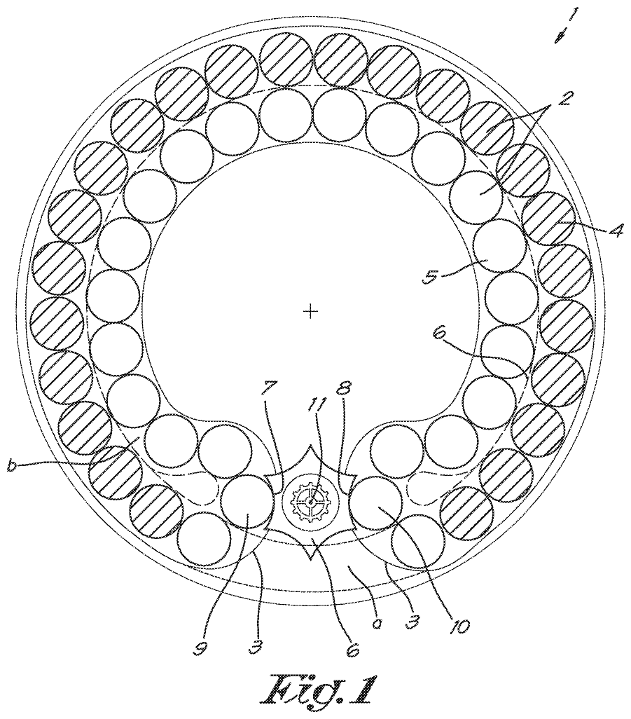

FIG. 1 schematically shows a top view of a circular display according to the invention;

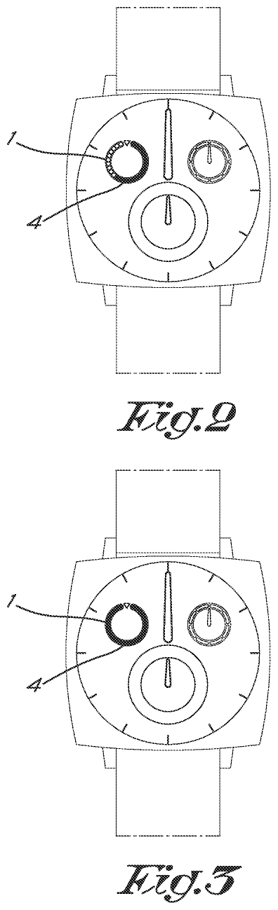

FIG. 2 shows FIG. 1 built into a mechanical precision timepiece;

FIG. 3 shows FIG. 2 but with the circular display in another position;

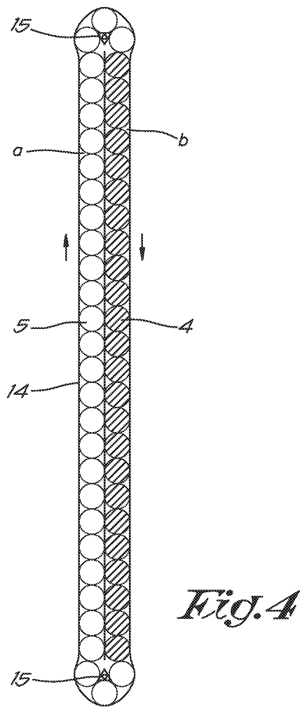

FIG. 4 shows a linear display according to the invention;

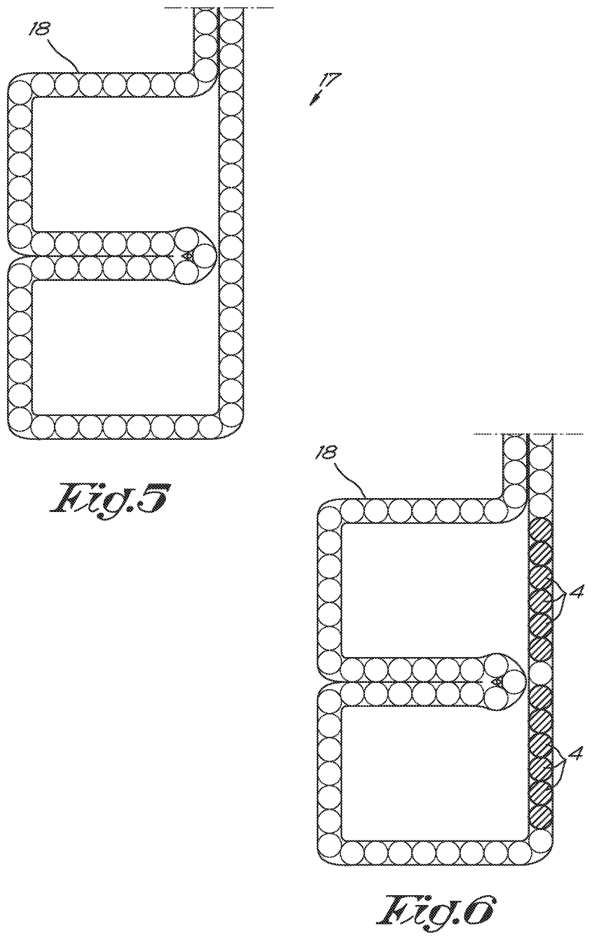

FIG. 5 shows an octagonal display according to the invention;

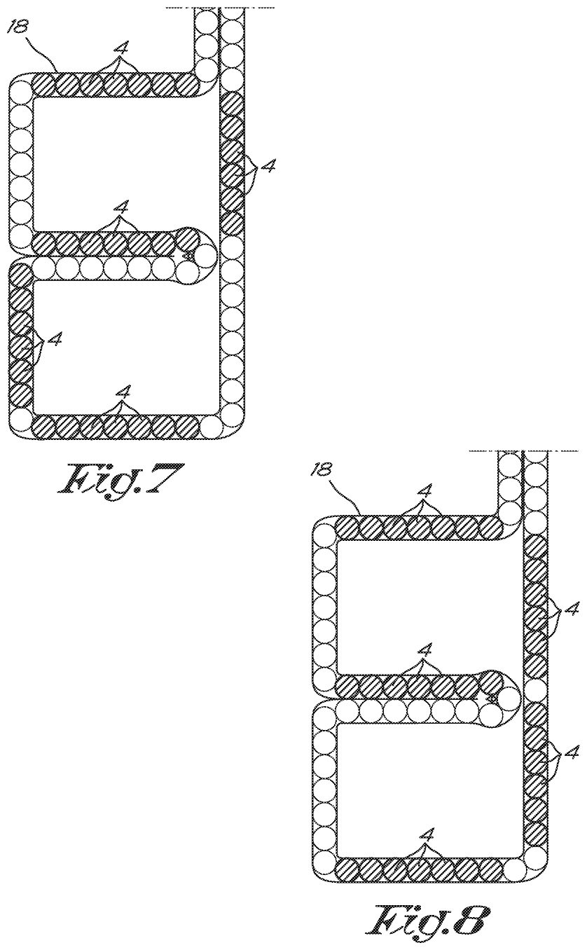

FIGS. 6, 7 and 8 show FIG. 5 but now with coloured segments which form digit 1, 2 and 3 respectively.

FIG. 1 schematically shows a mechanically driven display 1 according to the invention, whereby the balls form one consecutive string 2, which is guided in two concentric tracks a, b by a circular bed 3, only one concentric track of which is visible on the mechanically driven display 1. In this case the string 2 consists of a segment 4 of twenty-four balls with a colour different from the background, represented here as shaded balls and a subsequent segment 5 of twenty-four balls which are not different from the background of the circular bed 3. The mechanical drive is driven by means of a pinion 6 which engages with the balls on the level of the two points 7, 8 where the outer concentric track a continues to the interior concentric track b and each of the two engaged balls 9, 10 make the transition from the outer a to the inner concentric track b or vice versa. The pinion 6 rotates around a shaft 11 which is perpendicular to the plane in which the balls move in the mechanically driven display 1.

FIG. 2 shows a front view 12 of a mechanical precision timepiece as specified in U.S. Pat. No. 8,743,664 provided with several pointers, but in which a circular mechanically driven display 1 with balls according to the invention is now integrated. Part of a segment 4 of twenty-four balls is visible, the balls of which differ in terms of colour from the background and in which every ball represents a time span of one hour.

FIG. 3 shows FIG. 2, but now the complete segment 4 of 24 balls is visible by the colour difference with the background, after completing a time span of 24 hours since the appearance of the first ball of the segment 4 on the mechanically driven display. At a glance it is clear that the full cycle of 24 hours is now completed.

In FIG. 4 the bed 14 is linear and the row of balls forms one consecutive string which is guided through the linear bed 14 in two parallel tracks a, b, being an upward track a and a downward track b, of which in this case only the downward track b is visible on the mechanically driven display.

In this case there are, for example, twenty-four coloured balls 4 which can fill an entire length of the window through which they are visible on the linear display. In this case the row of balls is driven by two pinions which can rotate clockwise or counter-clockwise simultaneously and make the coloured balls visible in the visible track b, whereby one or more coloured balls become visible on the display, as a unit for the represented parameter.

FIG. 5 shows yet another variant embodiment 17 of a mechanically driven display according to the invention, whereby the bed 18 forms an octagonal display and the row of balls forms one consecutive string which is guided by one folded track in which seven segments of the track are linear, said segments forming an octagonal figure. In said FIG. 5, the balls 5 all have the colour of the bed 18 and the background of the display and therefore are not visible.

In FIGS. 6, 7 and 8, the octagonal figure of FIG. 5 is shown but now with two to five segments of six coloured balls 4 which together form the digits 1, 2 and 3 in the octagonal display respectively.

The operation of the mechanically driven displays 1, 14, 17 according to the invention is very simple and as follows. A consecutive row of balls, which are moved through a bed by means of a mechanical drive, for example, based on one or more rotating pinions is always used, whereby one or more segments of the consecutive row of balls have a colour that deviates from the bed and the display over which they are moved. The number of coloured segments in the row of balls can be limited to one, as applied in a circular or linear display, or can vary from two to seven coloured segments, as applied in an octagonal display.

The use of one segment of coloured balls allows a visual analogue signal to be shown in a circular or linear display which is proportional to the quantity of a time span or of a physical parameter such as temperature or pressure, to be indicated.

The use of two to seven segments of coloured balls in one row of balls allows all digits from 0 to 9 to be represented in an octagonal display and consequently also allows digital values of a time span or another physical parameter to be read on a mechanically driven display according to the invention.

The row of balls is mechanically driven by one or more pinions which are able to rotate clockwise or counter-clockwise and move the desired row of balls in the bed of the octagonal display to show the desired digit. A fitting series of balls can be selected from a carrousel with ten series, one for each digit, to show the desired digit or one long series of balls can be used consisting of the ten desired rows for the ten digits from 0 to 9 one after the other and letting said long series move up with one desired row after a specific time interval, for example, one hour, such that the display shows the number of expired hours up to 9 hours.

When two displays next to each other are used which together show the desired digit from at least 0 to 24 or 0 to 99, the number of hours can be shown up to 24 hours in two digital digits.

For the visual analogue signal not only the length of the segment of coloured balls can be used, but a colour gradient can also be used across the segment of coloured balls, whereby the colour may also contain luminescent or phosphorescent components.

The present invention is by no means limited to the embodiments described as an example and shown in the drawings, but such a mechanically driven display can be realised according to different variants without departing from the scope of the invention, as is defined in the following claims.

1. Mechanically driven display for showing a value of a measured quantity such as a time period or a physical parameter, whereby the display consists of a row of balls, which are moved one after the other in one row through a fixed bed by means of at least one mechanical drive, and whereby the row of balls has the colour of the background and the fixed bed but whereby one or more segments of the row of balls have a colour that visibly deviates from the background colour in which the bed is integrated.

2. Mechanically driven display according to claim 1, characterised in that the fixed bed is circular, and the row of balls forms one consecutive string, which is guided in two concentric tracks through the circular bed, of which only one concentric track is visible on the display and in which a segment of the row of balls with a colour deviating from the background colour is visible with a length corresponding with a certain time period or the value of another physical parameter such as temperature or air pressure.

3. Mechanically driven display according to claim 2, characterised in that the row of balls is mechanically driven by at least one pinion which synchronously with the time or another parameter rotates clockwise or counter-clockwise around its rotation shaft perpendicular to the readable surface of said circular embodiment of a display according to the invention, whereby the balls are moved with a fixed speed through the bed depending on the chosen time span per ball.

4. Mechanically driven display according to claim 2, characterised in that the pinion engages the balls on the level of the two points where the outer concentric track (a) continues to the inner concentric track (b) and each of the two engaged balls (9, 10) makes the transition from the outer (a) to the inner (b) concentric track or vice versa.

5. Mechanically driven display according to claim 1, characterised in that the fixed bed is a linear bed is, and that the row of balls forms one consecutive string, which is guided in two parallel tracks (a, b) through the linear bed, being an upward and a downward track, of which in this case only the upward track on the mechanically driven display is visible through a window.

6. Mechanically driven display according to claim 5, characterised in that a number of coloured balls can fill up to an entire length of the window through which they are visible on the linear display.

7. Mechanically driven display according to claim 5, characterised in that the row of balls is driven by two pinions which can rotate clockwise or counter-clockwise simultaneously and make the coloured balls visible in the visible track, whereby one or more coloured balls become visible on the display, as a unit for the represented parameter.

8. Mechanically driven display according to claim 1, characterised in that the fixed bed is an octagonal bed and the row of balls forms one consecutive string which is guided through one folded track in which seven segments of the track are linear and together form an octagonal figure.

9. Mechanically driven display according to claim 8, characterised in that one or more segments of the row of coloured balls which form one string, can take up one or more of the seven linear segments and can make said one or more segments visible on the octagonal bed of the display.

10. Mechanically driven display according to claim 9, characterised in that the segments of the row of coloured balls can show the digits 0 to 9 solely by making the fitting two to six segments of the string of balls, which fit in the two to six linear segments in the octagonal bed, in a noticeable colour relative to the background colour of the bed and the other balls.

11. Mechanically driven display according to claim 10, characterised in that the number of fitting segments of the string of balls varies from two for the digit 1, to three for the digit 7, to four for the digit 4, to five for the digits 2, 3, 5, to six for the digits 6, 9, 0.

12. Mechanically driven display according to claim 9, characterised in that the row of balls is mechanically driven by one or more pinions which are able to rotate clockwise or counter-clockwise and move the desired row of balls in the bed of the octagonal display to show the desired digit.

13. Mechanically driven display according to claim 11, characterised in that a fitting series of balls is selected from a carrousel with ten series, one for each digit, to show the desired digit.

14. Mechanically driven display according to claim 11, characterised in that one long series of balls consisting of the ten desired rows for the ten digits from 0 to 9 one after the other is used and letting said series move up one desired row after a certain time interval, for example one hour, such that the display shows the number of expired hours up to 9 hours.

15. Mechanically driven display according to claim 14, characterised in that two displays are used next to each other which together are able to show the desired digit from at least 0 to 24 or 0 to 99, such that the number of hours is shown in two digital digits.

16. Mechanically driven display according to claim 6, characterised in that not only the length of the segment of coloured balls is used, but a colour gradient is also used across the segment of coloured balls, whereby the colour may also contain luminescent or phosphorescent components.

17. Mechanically driven display according to claim 1, characterised in that it is applied for showing measured parameters in motion measurement systems, pedometers or gym trackers which show one or more parameters on a display.
